(19) United States
(12) Patent Application Publication
(10) Pub. No.: US 2003/0083905 A1
(43) Pub. Date: May 1, 2003

(54) Mobile productivity tool permitting audio file attachments

(76) Inventor: Vincent C. Jacobson, Eden Prairie, MN (US)

Correspondence Address: Oppenheimer Wolff & Donnelly LLP, Suite 3300, 45 South Seventh Street, Minneapolis, MN, 55402-1609, US

(21) Appl. No.: 10/263,628

(22) Filed: Oct. 3, 2002

Related U.S. Application Data
(63) Continuation-in-part of application No. 10/226,293, filed on Aug. 22, 2002.
(60) Provisional application No. 60/314,992, filed on Aug. 24, 2001.

(51) Int. Cl. G06F 17/60; G06F 7/00; G06F 17/00

(52) U.S. Cl. 705/3; 707/104.1; 700/94

(57) ABSTRACT

A productivity tool (for a medical clinic, veterinary clinic, or other non-medical environments) that embeds digital audio records in patient or customer encounter records in an encounter-centric manner such that the records are associated to the applicable encounter within a particular visit.

### CROSS-REFERENCE TO RELATED APPLICATION

This application is a continuation-in-part of U.S. Application Ser. No. 10/226,293 filed on Aug. 22, 2002, which claims the benefit of U.S. Provisional Application No. 60/314,992 filed on Aug. 24, 2001. The contents of the two related applications are incorporated herein by reference.

### BACKGROUND OF THE INVENTION

The present invention is a productivity tool for healthcare professionals. The invention provides a solution to problems found in other tools in the prior art, specifically how to store audio records of clinician encounters with patients in a manner allowing the preservation of these records over time, yet affiliating a specific audio record with the corresponding patient visit and encounter.

Many clinicians dictate notes regarding their encounters with a patient on a patient's visit. This dictation is then transcribed by the clinician's secretary, and the resulting transcription becomes part of the patient's medical records as documentation for that visit. The problem with this dictation/transcription process is that errors are introduced that cannot be corrected in a timely manner. Furthermore, following transcription the audio recording is destroyed, which does not allow the clinician to correct errors in the transcription. An obvious solution to this problem is to retain the audio tapes on which the dictation is recorded, but even if the dictation tapes were retained to allow correction, it would be difficult to correlate tapes the specific encounter records. Furthermore, the storage of many tapes would soon become cost prohibitive. Finally, the clinician does not have time to perform a detailed review of the transcription. Errors will only be corrected if the physician remembers the details of the patient visit when he next looks at the patient record, which may be many months or years in the future.

The art does not provide a solution to this problem. It is possible for the clinician to make a more complete record of his encounter with the patient, and then transcribe his own notes, but modern medical practice and time constraints do not allow the clinician to do this. The clinician could also enter information into the productivity tool taught in the related application entitled “Mobile Productivity Tool for Healthcare Providers” (U.S. Application Ser. No. 10/226,293 filed on Aug. 22, 2002), but this process again is too time consuming. In both failing solutions, each process is slower than dictation, and during that longer period in which the clinician is entering information, details will inevitably be forgotten before they can be captured in the record.

In the near future paper records may be replaced with electronic records, and although clinician notes may still be transcribed and stored in an electronic format, the original audio recording may also be of value for such purposes as being able to correct discovered mistakes or to save voice inflections by the examining clinician. Storing audio records in a digital format and then combined with electronic record keeping, would seem to be a natural way to expand the amount of valuable patient information available to treating clinicians. However, the need for the clinician to carry additional equipment and the logistics of associating audio records with the appropriate patient records present a prohibitive barrier to use. What is needed in the art is a system that would eliminate (or at least reduce) these barriers.

### SUMMARY OF THE INVENTION

The present invention provides the ability to store audio records recorded during medical encounters in a clinical environment, and to associate those audio records with the patient's medical records accurately, quickly, and reliably. One embodiment of the present invention is based on a novel combination of capabilities: digital audio recording and clinical patient encounter information recording, transfer, and storage. In one embodiment of the present invention, a computer program, stored in a computer's memory, stores records that correspond to a series of patients, where for each individual patient record there are zero or more visit records. For each visit record there is at least one encounter record. In some embodiments, the encounter and visit record are combined into the same record. Upon receiving a digital audio record, the computer program embeds the digital audio record in the patient's medical records at the appropriate corresponding encounter record. In some embodiments, the program is stored on a mobile computing device (MCD). It may communicate the digital audio records with another MCD or computer. The invention may be used in an environment beyond the clinical environment, including the veterinary environment and other non-medical environments, such as law enforcement.

### BRIEF DESCRIPTION OF THE DRAWINGS

FIG. 1 is a block diagram showing the components for one embodiment of the present invention.

FIG. 2 is a block diagram showing the components for one embodiment of the present invention in which a first mobile computing device communicates with a second mobile computing device.

### DETAILED DESCRIPTION OF THE INVENTION

The detailed description of the invention presented below is just one of many possible embodiments of the invention. The software implementation of this invention consists of implementing the following components:

(a) Provide a user interface control within the encounter context to provide for activation of digital audio capture hardware;

(b) Implement a database design that can be used to save the captured audio data along with encounter relationship identifiers to be used to associate it with the contextual encounter;

(c) Implement software to capture and save the digital information produced by the digital audio capture hardware into the audio capture database;

(d) Provide a user interface control within the encounter context to provide for “playing back” audio information stored within the encounter context; and

(e) Implement software to retrieve information from the database and play it on the MCD speaker.

One skilled in the art will recognize that this description can be used to readily understand, make, and use the inventive aspects of the present invention as part of a mobile productivity tool. While the embodiment described and shown is a tool for healthcare professionals, one skilled in the art understands that these techniques can be easily transferred to other industries.

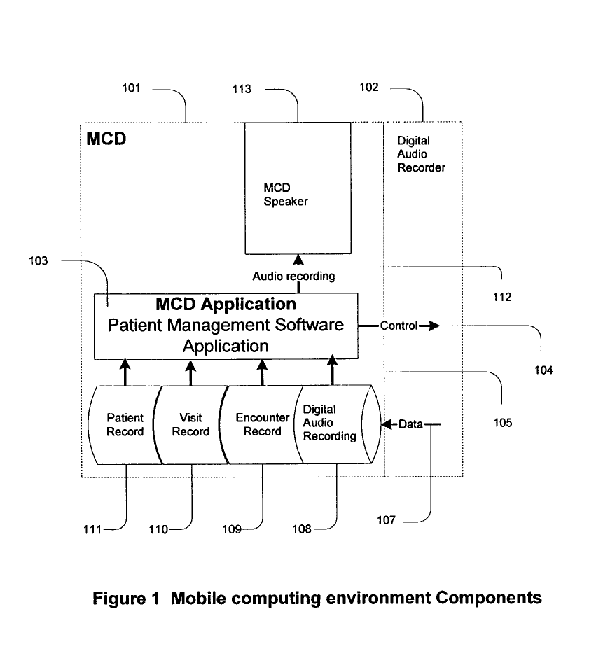

This invention relies upon using a digital audio recording capable mobile computing device (“MCD”). Referring to FIG. 1, such an MCD 101 is a member of a class of computers intended for use in a mobile environment, is typically hand-held, and typically incorporates mechanisms used for exchanging applications and data with other computers that are either mobile or stationary. Such MCDs include PALM PILOT brand, SONY brand, and HANDSPRING brand products that run the PALM brand operating system, as well as the Compaq brand IPAQ model that runs the Windows CE brand operating system. In the marketplace, an MCD is sometimes referred to as a personal digital assistant or the acronym PDA (for personal digital assistant). However, the definition of an MCD is not limited to the products listed or any other product that exists now or in the future.

The digital audio recording 102 capability may be an intrinsic capability of the MCD 101 or result from optional or after-market extensions 102 added to the MCD 101. Hence, separate parts may comprise the MCD 101 and digital audio recording device 102, such that the digital audio recording device expands the capabilities of the MCD 101, or, alternatively, the digital audio recording device 102 may be an intrinsic capability of the MCD 101. The MCD 101 is capable of executing a software program 103 designed to save 108 information recorded by the MCD via the digital audio recording device 102. The software program is also capable of storing 104 the digital audio records, and other patient records, in a separate database environment. This combination of equipment and software operate to record a digital audio record 107, store the digital audio record 108 within the MCD, and associate it contextually and relationally with the rest of the information, amassed during a patient visit, within the encounter context (stored as a patient record 111, a visit record 110, and/or an encounter record 109) at the time the digital audio record is recorded. The MCD application 103 can retrieve 105 the stored information and send 112 the digital audio record to the MCD speaker 113 to allow a user of the MCD to listen to the digital audio record.

There are many benefits to this invention. Some of these benefits include: (1) the clinician has only a single device to carry because the MCD 101 and the digital audio recording device 102 are the same physical device (either intrinsically or through combination); (2) the clinician need not make any intentional act to establish a correct relationship between the digital audio record and its contextual encounter record because the MCD application 103 manages this association of data; and (3) digital audio records from prior encounters are immediately available for reference to allow the clinician to review patient notes before, during, and after patient encounters. The applications of this invention are important in practice both for monitoring progressive conditions and maintaining more accurate patient records.

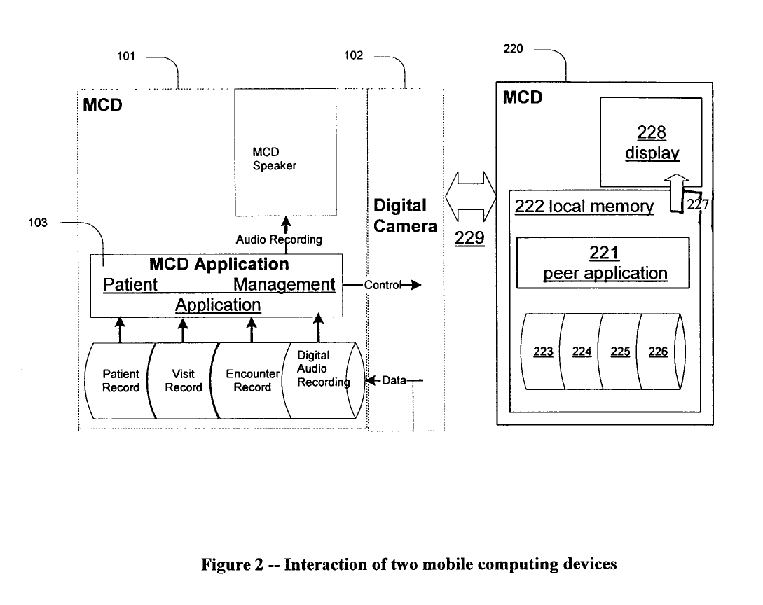

A second embodiment of this invention (illustrated in FIG. 2) is used in an environment where the data used in the MCD 101 is also conveyed 229 to another MCD 220, using a conventional MCD mechanism such as IrDA beaming, to provide the patient encounter information and contextually associated digital audio records to another clinician. In this embodiment, the information received by the peer application 221 is stored 222 in its local memory 223-226 for its own future use. The stored information can then be retrieved 222 from its storage location by the MCD application 221 and sent 227 to its speaker 228 for listening in context when reviewing the associated encounter record. Note that the peer MCD 220 does not require its own digital audio recorder unless it will also be recording digital audio records.

Another embodiment of this invention is used in an environment where the data used in the MCD is conveyed to another computer in a stationary environment having a compatible information access structure, such that the MCD-collected patient encounter information and contextually associated digital audio records are available for storage, review, and retrieval using the stationary computer.

Another embodiment of this invention is used in an environment where the data used in the MCD is conveyed to another computer in a stationary environment having a more limited information access structure, such that the MCD collects patient encounter information, and this collected information is available for storage, review, and retrieval using the stationary computer, or retrieve, transfer, and review it using an MCD.

Another embodiment of this invention is one of the above described embodiments, but deployed in an environment beyond the clinical health care setting. Alternative environments in which an embodiment of this invention may be used include veterinary medicine, real estate, automobile appraisal applications, law enforcement activities, and physical asset inventory applications.

The MCD application 103 and/or peer application 221 can be created using any of several computer programming languages known in the art.

What is claimed is:

1. A computer program embodied on a computer readable medium, when executed by a computer configures the computer to embed audio data in medical patient records, the computer program comprising:
a code segment for storing to memory and retrieving from memory multiple context-centered records corresponding to multiple patients, wherein for each patient the context-centered records comprise a patient record and zero or more visit records, and wherein for each visit record there is at least one encounter record;
a code segment for receiving digital audio data representing an audio recording; and
a code segment for associating the digital audio data to an encounter record for a patient.

2. The computer program from claim 1 wherein the visit record and the encounter record are combined.

3. The computer program from claim 1 wherein the computer is a mobile computing device.

4. The computer program from claim 1 further comprising a code segment for sending the digital audio data to a second computer.

5. The computer program from claim 1 further comprising a code segment for synchronizing multiple context-centered records with at least one enterprise application.

6. The computer program from claim 1 wherein the context-centered records are structured for a medical clinic environment.

7. The computer program from claim 1 wherein the context-centered records are structured for a veterinary clinic environment.

8. A computer program embodied on a computer readable medium, when executed by a computer configures the computer to embed audio data in database records, the computer program comprising:
a code segment for storing to memory and retrieving from memory multiple context-centered records corresponding to multiple customers, wherein for each customer the context-centered records comprise a customer record and at least one encounter record;
a code segment for receiving digital audio data representing an audio recording; and
a code segment for associating the digital audio data to an encounter record for a customer.

9. The computer program from claim 8 in which the customers are automobile appraisal clients.

10. The computer program from claim 8 in which the customers are real estate clients.

11. The computer program from claim 8 in which the customers are law enforcement personnel.

12. The computer program from claim 8 in which the customers are asset inventory clients.

13. The computer program from claim 8 in which the customers are inanimate physical assets.

14. A computer program embodied on a computer readable medium, when executed by a computer configures the computer to embed digital data in medical patient records, the computer program comprising:
a code segment for storing to memory and retrieving from memory a plurality of context-centered records corresponding to a plurality of patients, wherein for each of the plurality of patients, the context-centered records comprise a patient record and zero or more visit records, and wherein for each visit record there is at least one encounter record;
a code segment for receiving digital data;
a code segment for associating the digital data to a first encounter record for a first patient;
a code segment for storing the digital data in the memory.
